(19) United States
(12) Patent Application Publication
(10) Pub. No.: US 2013/0138888 A1
(43) Pub. Date: May 30, 2013

(54) STORING A TARGET ADDRESS OF A CONTROL TRANSFER INSTRUCTION IN AN INSTRUCTION FIELD

(71) Applicants: Jama I. Barreh, Austin, TX (US); Manish K. Shah, Austin, TX (US); Christopher H. Olson, Austin, TX (US)

(72) Inventors: Jama I. Barreh, Austin, TX (US); Manish K. Shah, Austin, TX (US); Christopher H. Olson, Austin, TX (US)

(21) Appl. No.: 13/307,850

(22) Filed: Nov. 30, 2011

(51) Int. Cl. G06F 12/08

(52) U.S. Cl. 711/125; 711/E12.02

(57) ABSTRACT

A control transfer instruction (CTI), such as a branch, jump, etc., may have an offset value for a control transfer that is to be performed. The offset value may be usable to compute a target address for the CTI (e.g., the address of a next instruction to be executed for a thread or instruction stream). The offset may be specified relative to a program counter. In response to detecting a specified offset value, the CTI may be modified to include at least a portion of a computed target address. Information indicating this modification has been performed may be stored, for example, in a pre-decode bit. In some cases, CTI modification may be performed only when a target address is a “near” target, rather than a “far” target. Modifying CTIs as described herein may eliminate redundant address calculations and produce a savings of power and/or time in some embodiments.

### BACKGROUND

This disclosure relates to the execution of control transfer instructions (CTIs) in a multi-threaded computing environment, and, more specifically, to the calculation of target addresses for CTIs in such an environment.

A modern computer processor may achieve high performance by predicting the direction and the target address of CTIs, such as branches, calls, and returns. In the event that a predicted path for a given CTI is actually the path that is taken for that instruction, the target address of the CTI must either then be calculated or be readily available so that additional instructions can be fetched. In some designs, however, target address calculation may occur more than once, producing inefficiencies.

### SUMMARY

Techniques and structures are disclosed herein that relate to the modification of control transfer instructions. Target addresses for CTIs may be used in association with at least two aspects of processing: instruction execution, and instruction fetch/instruction prediction. For example, target address calculation for CTIs is typically performed at an execution unit each time that the CTI is executed. This creates both timing and power pressure on the execution unit. The target address of a given CTI may also be needed at a fetch unit so that the fetch unit can pre-fetch instructions located at that target address (e.g., in accordance with a branch prediction). Thus, in addition to the execution unit, target address calculation may also be performed at a fetch unit. This address calculation can be time consuming and can add to the timing pressures of the fetch unit. Further, if the target address has to be calculated each time the CTI is fetched, this may create an upward pressure on power consumption.

Thus, performing a target address calculation in two locations and/or on multiple occasions (e.g., in the case of repeated execution) may be disadvantageous. For at least some types of CTIs, however, target address calculation can be performed at one central location, which may be located partially or wholly outside a fetch unit or execution unit in some embodiments. Further, repetitive calculations can be reduced or eliminated in embodiments described herein by storing information that indicates a target calculation for a given CTI has been performed previously.

In the case of an immediate CTI, for example, the CTI may specify a direct offset relative to another value, such as program counter for the CTI. In one embodiment, the target address will be initially calculated, and a portion will be stored within the CTI itself by modifying the CTI (e.g., overwriting the field that previously held the offset value). The target address can later be reconstructed by concatenating the upper bits of the PC with the lower bits of the target address that are stored within the CTI. This may be a less expensive operation than a full recalculation of the target address using mathematical addition or other operations. Further, because information may be stored indicating that a CTI has previously been modified, an execution unit or branch unit (for example) can detect that a target has already been calculated, thus avoiding unnecessary further calculations.

The teachings of this disclosure and the claims, however, are expressly not limited by the features and embodiments discussed in the summary above.

### BRIEF DESCRIPTION OF THE DRAWINGS

The following detailed description makes reference to the accompanying drawings, which are now briefly described.

FIG. 1 is a block diagram of one embodiment of a multi-core processor.

FIG. 2 is a block diagram of one embodiment of a processor core.

FIG. 3 is a block diagram of a more specific embodiment of a processor core, including a control transfer unit.

FIG. 4A is a block diagram illustrating one embodiment of a computer instruction.

FIG. 4B and FIG. 4C are block diagrams block diagrams illustrating a control transfer instruction before and after a modification on the instruction is performed.

FIG. 5 is a block diagram illustrating one embodiment of an control transfer unit that is configured to perform various operations with regard to control transfer instructions, including target address calculation and instruction modification.

FIG. 6 is a flow diagram illustrating one embodiment of a method in which a control transfer instruction may be modified.

FIG. 7 is a block diagram illustrating an exemplary system embodiment.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising a control transfer unit . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component.

“Based On.” As used herein, this term is used to describe one or more factors that affect a determination. This term does not foreclose additional factors that may affect a determination. That is, a determination may be solely based on those factors or may be based, at least in part, on those factors. Consider the phrase “determine A based on B.” While B may be a factor that affects the determination of A, such a phrase does not foreclose the determination of A from also being based on C. In other instances, however, A may be determined based solely on B.

### Introduction

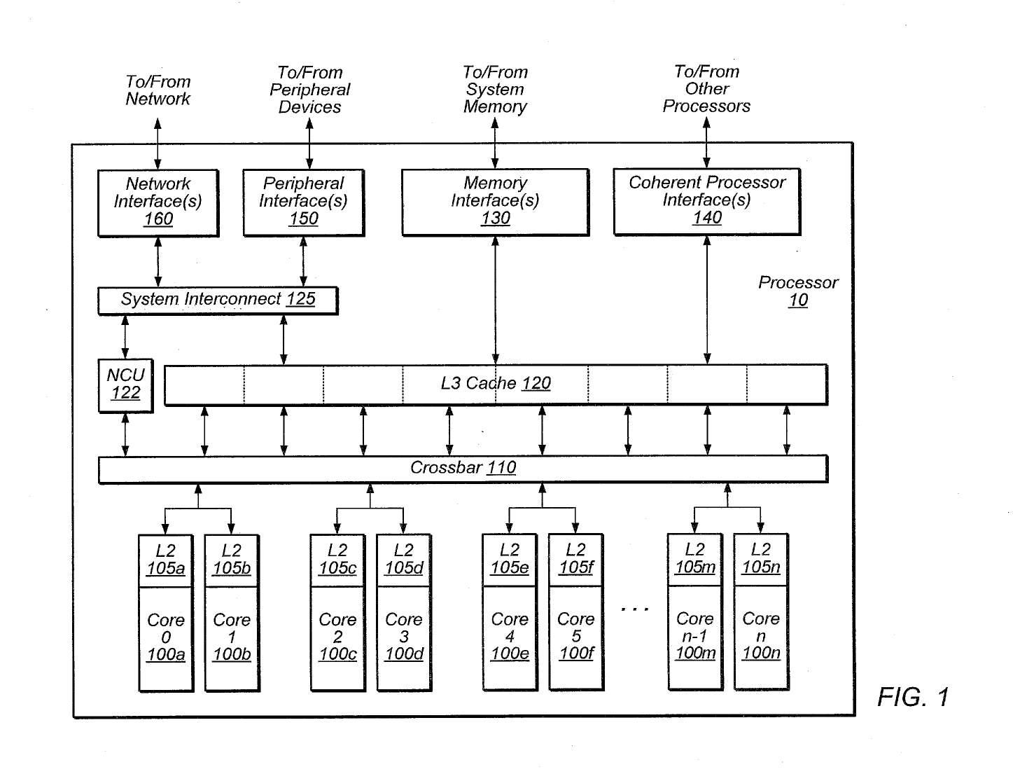

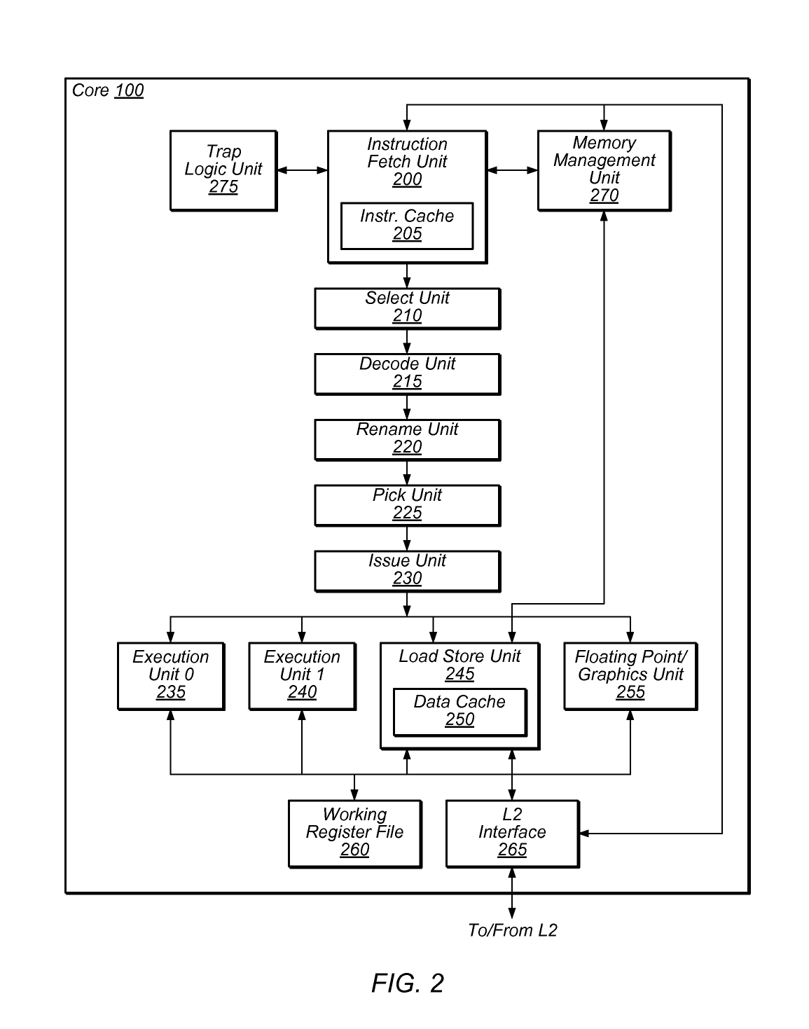

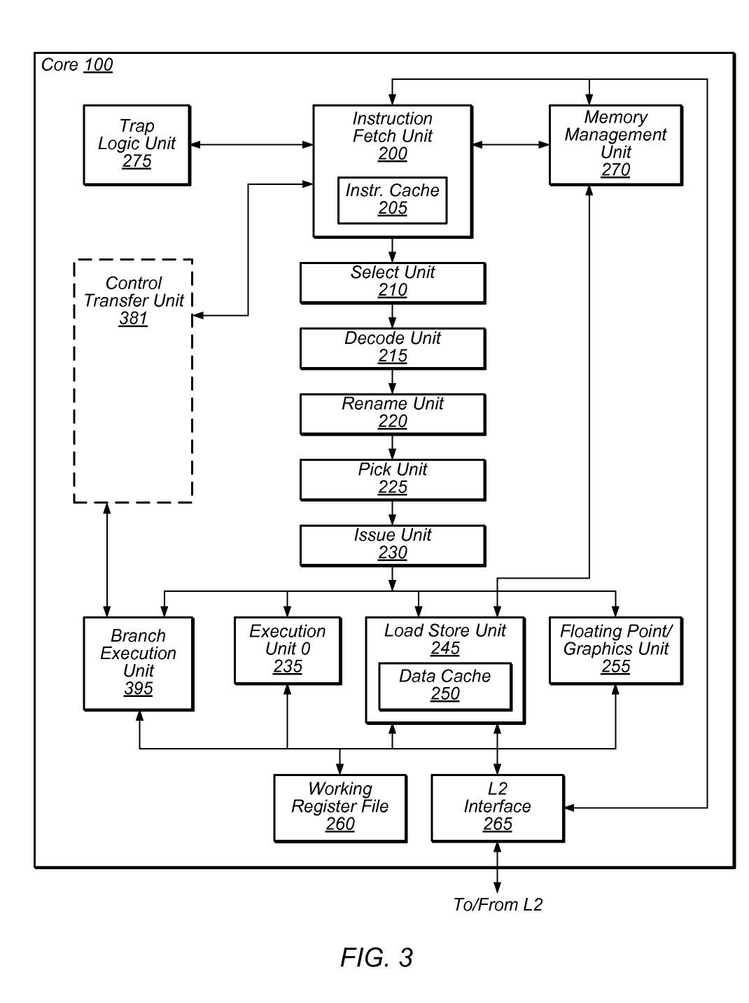

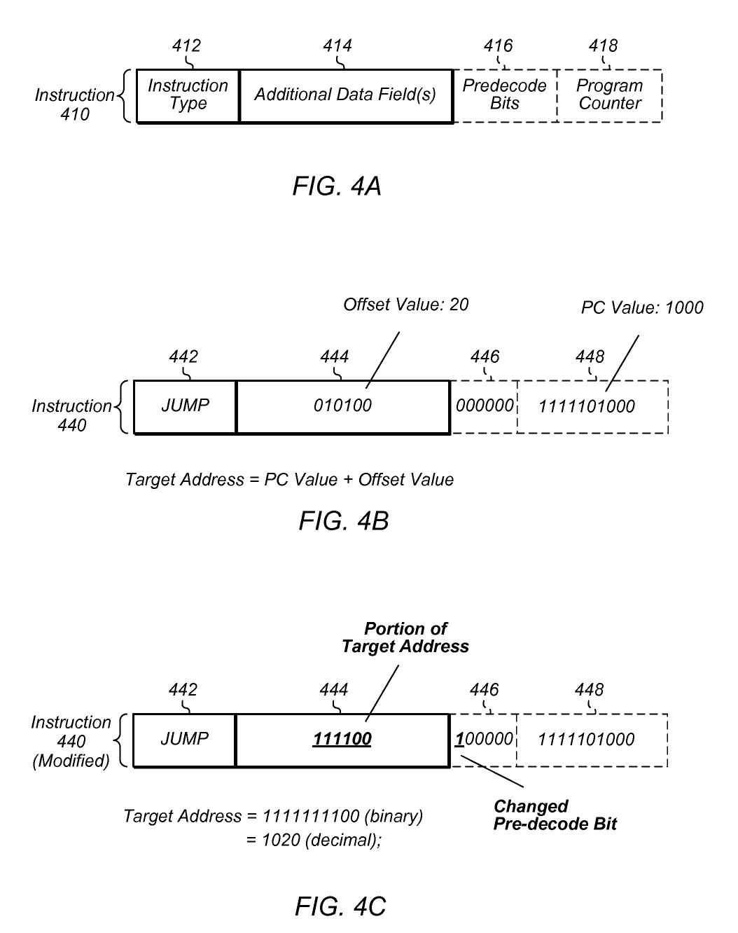

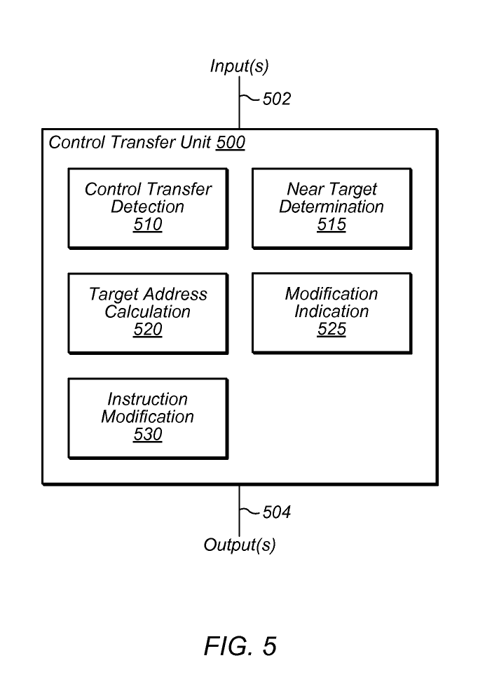

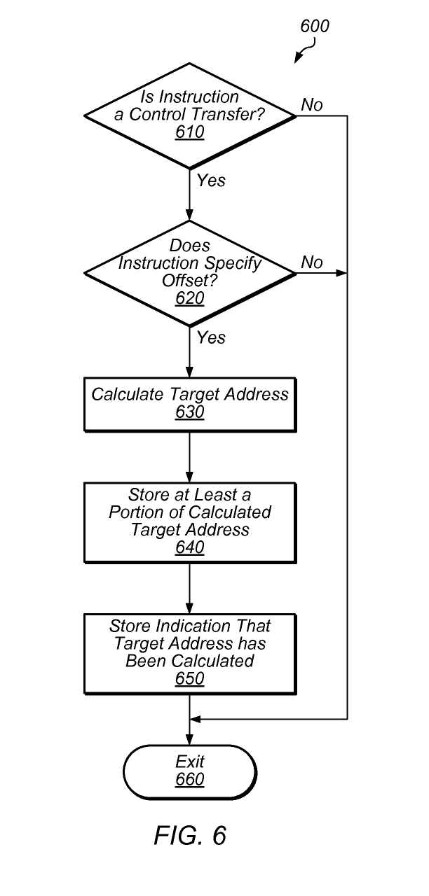

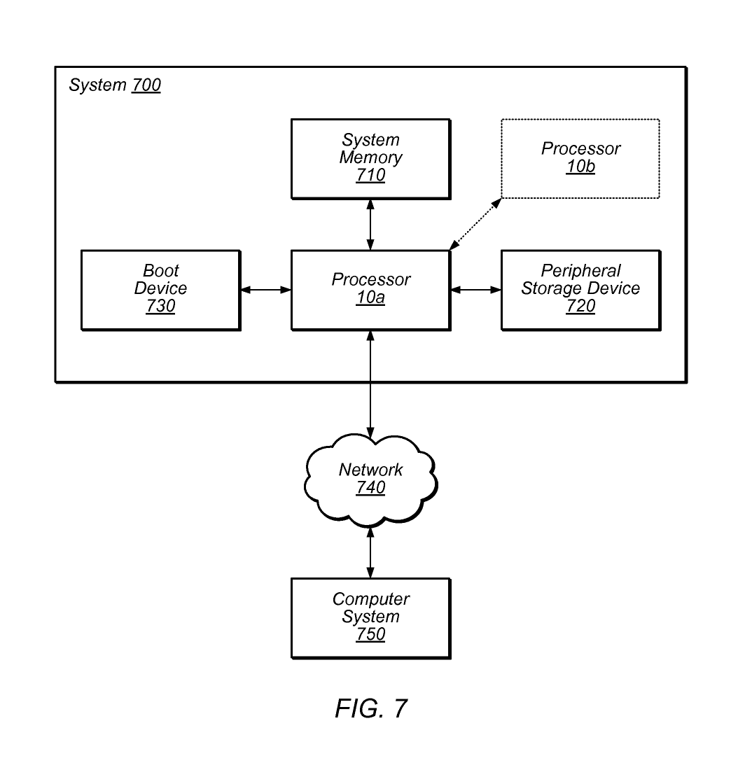

The present disclosure describes various embodiments relating to circuitry that facilitates handling and/or modification of control transfer instructions. FIGS. 1 and 2 present an overview of an exemplary multithreaded processor in which such circuitry may be included. FIG. 3 presents an exemplary embodiment of a control transfer unit, shown relative to the processor embodiment of FIG. 2. FIGS. 4A-4C present various embodiments of instructions, including a before and after depiction of a control transfer instruction that has been modified to include a portion of a target address. FIG. 5 presents a further embodiment of a control transfer unit that is configured to perform operations on control transfer instructions. FIG. 6 presents an exemplary method for control transfer instruction modification, and lastly, FIG. 7 presents an overview of a computer system in which structures and techniques described herein may be used.

[Inventors: You may wish to skim the following overview sections, and review in greater detail beginning on page 28]

### Processor Overview

Turning now to FIG. 1, a block diagram illustrating one embodiment of a processor 10 is shown. In certain embodiments, processor 10 may be multithreaded. In the illustrated embodiment, processor 10 includes a number of processor cores 100a-n, which are also designated “core 0” though “core n.” As used herein, the term processor may refer to an apparatus having a single processor core or an apparatus that includes two or more processor cores. Various embodiments of processor 10 may include varying numbers of cores 100, such as 8, 16, or any other suitable number. Each of cores 100 is coupled to a corresponding L2 cache 105a-n, which in turn coupled to L3 cache 120 via a crossbar 110. Cores 100a-n and L2 caches 105a-n may be generically referred to, either collectively or individually, as core(s) 100 and L2 cache(s) 105, respectively.

Via crossbar 110 and L3 cache 120, cores 100 may be coupled to a variety of devices that may be located externally to processor 10. In the illustrated embodiment, one or more memory interface(s) 130 may be configured to couple to one or more banks of system memory (not shown). One or more coherent processor interface(s) 140 may be configured to couple processor 10 to other processors (e.g., in a multiprocessor environment employing multiple units of processor 10). Additionally, system interconnect 125 couples cores 100 to one or more peripheral interface(s) 150 and network interface(s) 160. As described in greater detail below, these interfaces may be configured to couple processor 10 to various peripheral devices and networks.

Cores 100 may be configured to execute instructions and to process data according to a particular instruction set architecture (ISA). In one embodiment, cores 100 may be configured to implement a version of the SPARC® ISA, such as SPARC® V9, UltraSPARC Architecture 2005, UltraSPARC Architecture 2007, or UltraSPARC Architecture 2009, for example. However, in other embodiments it is contemplated that any desired ISA may be employed, such as x86 (32-bit or 64-bit versions), PowerPC® or MIPS®, for example.

In the illustrated embodiment of FIG. 1, each of cores 100 may be configured to operate independently of the others, such that all cores 100 may execute in parallel (i.e., concurrently). Additionally, as described below in conjunction with the descriptions of FIG. 2, in some embodiments, each of cores 100 may be configured to execute multiple threads concurrently, where a given thread may include a set of instructions that may execute independently of instructions from another thread. (For example, an individual software process, such as an application, may consist of one or more threads that may be scheduled for execution by an operating system.) Such a core 100 may also be referred to as a multithreaded (MT) core. In one embodiment, each of cores 100 may be configured to concurrently execute instructions from a variable number of threads, up to eight concurrently-executing threads. In a 16-core implementation, processor 10 could thus concurrently execute up to 128 threads. However, in other embodiments it is contemplated that other numbers of cores 100 may be provided, and that cores 100 may concurrently process different numbers of threads.

Additionally, as described in greater detail below, in some embodiments, each of cores 100 may be configured to execute certain instructions out of program order, which may also be referred to herein as out-of-order execution, or simply OOO. As an example of out-of-order execution, for a particular thread, there may be instructions that are subsequent in program order to a given instruction yet do not depend on the given instruction. If execution of the given instruction is delayed for some reason (e.g., owing to a cache miss), the later instructions may execute before the given instruction completes, which may improve overall performance of the executing thread.

As shown in FIG. 1, in one embodiment, each core 100 may have a dedicated corresponding L2 cache 105. In one embodiment, L2 cache 105 may be configured as a set-associative, write-back cache that is fully inclusive of first-level cache state (e.g., instruction and data caches within core 100). To maintain coherence with first-level caches, embodiments of L2 cache 105 may implement a reverse directory that maintains a virtual copy of the first-level cache tags. L2 cache 105 may implement a coherence protocol (e.g., the MESI protocol) to maintain coherence with other caches within processor 10. In one embodiment, L2 cache 105 may enforce a Total Store Ordering (TSO) model of execution in which all store instructions from the same thread must complete in program order.

In various embodiments, L2 cache 105 may include a variety of structures configured to support cache functionality and performance. For example, L2 cache 105 may include a miss buffer configured to store requests that miss the L2, a fill buffer configured to temporarily store data returning from L3 cache 120, a write-back buffer configured to temporarily store dirty evicted data and snoop copyback data, and/or a snoop buffer configured to store snoop requests received from L3 cache 120. In one embodiment, L2 cache 105 may implement a history-based prefetcher that may attempt to analyze L2 miss behavior and correspondingly generate prefetch requests to L3 cache 120.

Crossbar 110 may be configured to manage data flow between L2 caches 105 and the shared L3 cache 120. In one embodiment, crossbar 110 may include logic (such as multiplexers or a switch fabric, for example) that allows any L2 cache 105 to access any bank of L3 cache 120, and that conversely allows data to be returned from any L3 bank to any L2 cache 105. That is, crossbar 110 may be configured as an M-to-N crossbar that allows for generalized point-to-point communication. However, in other embodiments, other interconnection schemes may be employed between L2 caches 105 and L3 cache 120. For example, a mesh, ring, or other suitable topology may be utilized.

Crossbar 110 may be configured to concurrently process data requests from L2 caches 105 to L3 cache 120 as well as data responses from L3 cache 120 to L2 caches 105. In some embodiments, crossbar 110 may include logic to queue data requests and/or responses, such that requests and responses may not block other activity while waiting for service. Additionally, in one embodiment crossbar 110 may be configured to arbitrate conflicts that may occur when multiple L2 caches 105 attempt to access a single bank of L3 cache 120, or vice versa.

L3 cache 120 may be configured to cache instructions and data for use by cores 100. In the illustrated embodiment, L3 cache 120 may be organized into eight separately addressable banks that may each be independently accessed, such that in the absence of conflicts, each bank may concurrently return data to a respective L2 cache 105. In some embodiments, each individual bank may be implemented using set-associative or direct-mapped techniques. For example, in one embodiment, L3 cache 120 may be an 8 megabyte (MB) cache, where each 1 MB bank is 16-way set associative with a 64-byte line size. L3 cache 120 may be implemented in some embodiments as a write-back cache in which written (dirty) data may not be written to system memory until a corresponding cache line is evicted. However, it is contemplated that in other embodiments, L3 cache 120 may be configured in any suitable fashion. For example, L3 cache 120 may be implemented with more or fewer banks, or in a scheme that does not employ independently-accessible banks; it may employ other bank sizes or cache geometries (e.g., different line sizes or degrees of set associativity); it may employ write through instead of write-back behavior; and it may or may not allocate on a write miss. Other variations of the L3 cache 120 configuration are possible and contemplated.

In some embodiments, L3 cache 120 may implement queues for requests arriving from and results to be sent to crossbar 110. Additionally, in some embodiments L3 cache 120 may implement a fill buffer configured to store fill data arriving from memory interface 130, a write-back buffer configured to store dirty evicted data to be written to memory, and/or a miss buffer configured to store L3 cache accesses that cannot be processed as simple cache hits (e.g., L3 cache misses, cache accesses matching older misses, accesses such as atomic operations that may require multiple cache accesses, etc.). L3 cache 120 may variously be implemented as single-ported or multiported (i.e., capable of processing multiple concurrent read and/or write accesses). In either case, L3 cache 120 may implement arbitration logic to prioritize cache access among various cache read and write requestors.

Not all external accesses from cores 100 necessarily proceed through L3 cache 120. In the illustrated embodiment, non-cacheable unit (NCU) 122 may be configured to process requests from cores 100 for non-cacheable data, such as data from 110 devices as described below with respect to peripheral interface(s) 150 and network interface(s) 160.

Memory interface 130 may be configured to manage the transfer of data between L3 cache 120 and system memory, for example in response to cache fill requests and data evictions. In some embodiments, multiple instances of memory interface 130 may be implemented, with each instance configured to control a respective bank of system memory. Memory interface 130 may be configured to interface to any suitable type of system memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM (RDRAM®), for example. In some embodiments, memory interface 130 may be configured to support interfacing to multiple different types of system memory.

In the illustrated embodiment, processor 10 may also be configured to receive data from sources other than system memory. System interconnect 125 may be configured to provide a central interface for such sources to exchange data with cores 100, L2 caches 105, and/or L3 cache 120. In some embodiments, system interconnect 125 may be configured to coordinate Direct Memory Access (DMA) transfers of data to and from system memory. For example, via memory interface 130, system interconnect 125 may coordinate DMA transfers between system memory and a network device attached via network interface 160, or between system memory and a peripheral device attached via peripheral interface 150.

Processor 10 may be configured for use in a multiprocessor environment with other instances of processor 10 or other compatible processors. In the illustrated embodiment, coherent processor interface(s) 140 may be configured to implement high-bandwidth, direct chip-to-chip communication between different processors in a manner that preserves memory coherence among the various processors (e.g., according to a coherence protocol that governs memory transactions).

Peripheral interface 150 may be configured to coordinate data transfer between processor 10 and one or more peripheral devices. Such peripheral devices may include, for example and without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 150 may implement one or more instances of a standard peripheral interface. For example, one embodiment of peripheral interface 150 may implement the Peripheral Component Interface Express (PCI Express™ or PCIe) standard according to generation 1.x, 2.0, 3.0, or another suitable variant of that standard, with any suitable number of I/O lanes. However, it is contemplated that any suitable interface standard or combination of standards may be employed. For example, in some embodiments peripheral interface 150 may be configured to implement a version of Universal Serial Bus (USB) protocol or IEEE 1394 (Firewire®) protocol in addition to or instead of PCI Express™.

Network interface 160 may be configured to coordinate data transfer between processor 10 and one or more network devices (e.g., networked computer systems or peripherals) coupled to processor 10 via a network. In one embodiment, network interface 160 may be configured to perform the data processing necessary to implement an Ethernet (IEEE 802.3) networking standard such as Gigabit Ethernet or 10-Gigabit Ethernet, for example. However, it is contemplated that any suitable networking standard may be implemented, including forthcoming standards such as 40-Gigabit Ethernet and 100-Gigabit Ethernet. In some embodiments, network interface 160 may be configured to implement other types of networking protocols, such as Fibre Channel, Fibre Channel over Ethernet (FCoE), Data Center Ethernet, Infiniband, and/or other suitable networking protocols. In some embodiments, network interface 160 may be configured to implement multiple discrete network interface ports.

### Overview of Dynamic Multithreading Processor Core

As mentioned above, in one embodiment each of cores 100 may be configured for multithreaded, out-of-order execution. More specifically, in one embodiment, each of cores 100 may be configured to perform dynamic multithreading. Generally speaking, under dynamic multithreading, the execution resources of cores 100 may be configured to efficiently process varying types of computational workloads that exhibit different performance characteristics and resource requirements. Such workloads may vary across a continuum that emphasizes different combinations of individual-thread and multiple-thread performance.

At one end of the continuum, a computational workload may include a number of independent tasks, where completing the aggregate set of tasks within certain performance criteria (e.g., an overall number of tasks per second) is a more significant factor in system performance than the rate at which any particular task is completed. For example, in certain types of server or transaction processing environments, there may be a high volume of individual client or customer requests (such as web page requests or file system accesses). In this context, individual requests may not be particularly sensitive to processor performance. For example, requests may be I/O-bound rather than processor-bound—completion of an individual request may require I/O accesses (e.g., to relatively slow memory, network, or storage devices) that dominate the overall time required to complete the request, relative to the processor effort involved. Thus, a processor that is capable of concurrently processing many such tasks (e.g., as independently executing threads) may exhibit better performance on such a workload than a processor that emphasizes the performance of only one or a small number of concurrent tasks.

At the other end of the continuum, a computational workload may include individual tasks whose performance is highly processor-sensitive. For example, a task that involves significant mathematical analysis and/or transformation (e.g., cryptography, graphics processing, scientific computing) may be more processor-bound than I/O-bound. Such tasks may benefit from processors that emphasize single-task performance, for example through speculative execution and exploitation of instruction-level parallelism.

Dynamic multithreading represents an attempt to allocate processor resources in a manner that flexibly adapts to workloads that vary along the continuum described above. In one embodiment, cores 100 may be configured to implement fine-grained multithreading, in which each core may select instructions to execute from among a pool of instructions corresponding to multiple threads, such that instructions from different threads may be scheduled to execute adjacently. For example, in a pipelined embodiment of core 100 employing fine-grained multithreading, instructions from different threads may occupy adjacent pipeline stages, such that instructions from several threads may be in various stages of execution during a given core processing cycle. Through the use of fine-grained multithreading, cores 100 may be configured to efficiently process workloads that depend more on concurrent thread processing than individual thread performance.

In one embodiment, cores 100 may also be configured to implement out-of-order processing, speculative execution, register renaming and/or other features that improve the performance of processor-dependent workloads. Moreover, cores 100 may be configured to dynamically allocate a variety of hardware resources among the threads that are actively executing at a given time, such that if fewer threads are executing, each individual thread may be able to take advantage of a greater share of the available hardware resources. This may result in increased individual thread performance when fewer threads are executing, while retaining the flexibility to support workloads that exhibit a greater number of threads that are less processor-dependent in their performance. In various embodiments, the resources of a given core 100 that may be dynamically allocated among a varying number of threads may include branch resources (e.g., branch predictor structures), load/store resources (e.g., load/store buffers and queues), instruction completion resources (e.g., reorder buffer structures and commit logic), instruction issue resources (e.g., instruction selection and scheduling structures), register rename resources (e.g., register mapping tables), and/or memory management unit resources (e.g., translation lookaside buffers, page walk resources).

One embodiment of core 100 that is configured to perform dynamic multithreading is illustrated in FIG. 2. In the illustrated embodiment, core 100 includes an instruction fetch unit (IFU) 200 that includes an instruction cache 205. IFU 200 is coupled to a memory management unit (MMU) 270, L2 interface 265, and trap logic unit (TLU) 275. IFU 200 is additionally coupled to an instruction processing pipeline that begins with a select unit 210 and proceeds in turn through a decode unit 215, a rename unit 220, a pick unit 225, and an issue unit 230. Issue unit 230 is coupled to issue instructions to any of a number of instruction execution resources: an execution unit 0 (EXU0) 235, an execution unit 1 (EXU1) 240, a load store unit (LSU) 245 that includes a data cache 250, and/or a floating-point/graphics unit (FGU) 255. These instruction execution resources are coupled to a working register file 260. Additionally, LSU 245 is coupled to L2 interface 265 and MMU 270.

In the following discussion, exemplary embodiments of each of the structures of the illustrated embodiment of core 100 are described. However, it is noted that the illustrated partitioning of resources is merely one example of how core 100 may be implemented. Alternative configurations and variations are possible and contemplated.

Instruction fetch unit 200 may be configured to provide instructions to the rest of core 100 for execution. In one embodiment, IFU 200 may be configured to select a thread to be fetched, fetch instructions from instruction cache 205 for the selected thread and buffer them for downstream processing, request data from L2 cache 105 in response to instruction cache misses, and predict the direction and target of control transfer instructions (e.g., branches). In some embodiments, IFU 200 may include a number of data structures in addition to instruction cache 205, such as an instruction translation lookaside buffer (ITLB), instruction buffers, and/or structures configured to store state that is relevant to thread selection and processing.

In one embodiment, during each execution cycle of core 100, IFU 200 may be configured to select one thread that will enter the IFU processing pipeline. Thread selection may take into account a variety of factors and conditions, some thread-specific and others IFU-specific. For example, certain instruction cache activities (e.g., cache fill), ITLB activities, or diagnostic activities may inhibit thread selection if these activities are occurring during a given execution cycle. Additionally, individual threads may be in specific states of readiness that affect their eligibility for selection. For example, a thread for which there is an outstanding instruction cache miss may not be eligible for selection until the miss is resolved. In some embodiments, those threads that are eligible to participate in thread selection may be divided into groups by priority, for example depending on the state of the thread or of the ability of the IFU pipeline to process the thread. In such embodiments, multiple levels of arbitration may be employed to perform thread selection: selection occurs first by group priority, and then within the selected group according to a suitable arbitration algorithm (e.g., a least-recently-fetched algorithm). However, it is noted that any suitable scheme for thread selection may be employed, including arbitration schemes that are more complex or simpler than those mentioned here.

Once a thread has been selected for fetching by IFU 200, instructions may actually be fetched for the selected thread. To perform the fetch, in one embodiment, IFU 200 may be configured to generate a fetch address to be supplied to instruction cache 205. In various embodiments, the fetch address may be generated as a function of a program counter associated with the selected thread, a predicted branch target address, or an address supplied in some other manner (e.g., through a test or diagnostic mode). The generated fetch address may then be applied to instruction cache 205 to determine whether there is a cache hit.

In some embodiments, accessing instruction cache 205 may include performing fetch address translation (e.g., in the case of a physically indexed and/or tagged cache), accessing a cache tag array, and comparing a retrieved cache tag to a requested tag to determine cache hit status. If there is a cache hit, IFU 200 may store the retrieved instructions within buffers for use by later stages of the instruction pipeline. If there is a cache miss, IFU 200 may coordinate retrieval of the missing cache data from L2 cache 105. In some embodiments, IFU 200 may also be configured to prefetch instructions into instruction cache 205 before the instructions are actually required to be fetched. For example, in the case of a cache miss, IFU 200 may be configured to retrieve the missing data for the requested fetch address as well as addresses that sequentially follow the requested fetch address, on the assumption that the following addresses are likely to be fetched in the near future.

In many ISAs, instruction execution proceeds sequentially according to instruction addresses (e.g., as reflected by one or more program counters). However, control transfer instructions (CTIs) such as branches, call/return instructions, or other types of instructions may cause the transfer of execution from a current fetch address to a nonsequential address. As mentioned above, IFU 200 may be configured to predict the direction and target of CTIs (or, in some embodiments, a subset of the CTIs that are defined for an ISA) in order to reduce the delays incurred by waiting until the effect of a CTI is known with certainty. In one embodiment, IFU 200 may be configured to implement a perceptron-based dynamic branch predictor, although any suitable type of branch predictor may be employed.

To implement branch prediction, IFU 200 may implement a variety of control and data structures in various embodiments, such as history registers that track prior branch history, weight tables that reflect relative weights or strengths of predictions, and/or target data structures that store fetch addresses that are predicted to be targets of a CTI. Also, in some embodiments, IFU 200 may further be configured to partially decode (or predecode) fetched instructions in order to facilitate branch prediction. A predicted fetch address for a given thread may be used as the fetch address when the given thread is selected for fetching by IFU 200. The outcome of the prediction may be validated when the CTI is actually executed (e.g., if the CTI is a conditional instruction, or if the CTI itself is in the path of another predicted CTI). If the prediction was incorrect, instructions along the predicted path that were fetched and issued may be cancelled.

Through the operations discussed above, IFU 200 may be configured to fetch and maintain a buffered pool of instructions from one or multiple threads, to be fed into the remainder of the instruction pipeline for execution. Generally speaking, select unit 210 may be configured to select and schedule threads for execution. In one embodiment, during any given execution cycle of core 100, select unit 210 may be configured to select up to one ready thread out of the maximum number of threads concurrently supported by core 100 (e.g., 8 threads), and may select up to two instructions from the selected thread for decoding by decode unit 215, although in other embodiments, a differing number of threads and instructions may be selected. In various embodiments, different conditions may affect whether a thread is ready for selection by select unit 210, such as branch mispredictions, unavailable instructions, or other conditions. To ensure fairness in thread selection, some embodiments of select unit 210 may employ arbitration among ready threads (e.g. a least-recently-used algorithm).

The particular instructions that are selected for decode by select unit 210 may be subject to the decode restrictions of decode unit 215; thus, in any given cycle, fewer than the maximum possible number of instructions may be selected. Additionally, in some embodiments, select unit 210 may be configured to allocate certain execution resources of core 100 to the selected instructions, so that the allocated resources will not be used for the benefit of another instruction until they are released. For example, select unit 210 may allocate resource tags for entries of a reorder buffer, load/store buffers, or other downstream resources that may be utilized during instruction execution.

Generally, decode unit 215 may be configured to prepare the instructions selected by select unit 210 for further processing. Decode unit 215 may be configured to identify the particular nature of an instruction (e.g., as specified by its opcode) and to determine the source and sink (i.e., destination) registers encoded in an instruction, if any. In some embodiments, decode unit 215 may be configured to detect certain dependencies among instructions, to remap architectural registers to a flat register space, and/or to convert certain complex instructions to two or more simpler instructions for execution. Additionally, in some embodiments, decode unit 215 may be configured to assign instructions to slots for subsequent scheduling. In one embodiment, two slots 0-1 may be defined, where slot 0 includes instructions executable in load/store unit 245 or execution units 235-240, and where slot 1 includes instructions executable in execution units 235-240, floating-point/graphics unit 255, and any branch instructions. However, in other embodiments, other numbers of slots and types of slot assignments may be employed, or slots may be omitted entirely.

Register renaming may facilitate the elimination of certain dependencies between instructions (e.g., write-after-read or “false” dependencies), which may in turn prevent unnecessary serialization of instruction execution. In one embodiment, rename unit 220 may be configured to rename the logical (i.e., architected) destination registers specified by instructions by mapping them to a physical register space, resolving false dependencies in the process. In some embodiments, rename unit 220 may maintain mapping tables that reflect the relationship between logical registers and the physical registers to which they are mapped.

Once decoded and renamed, instructions may be ready to be scheduled for execution. In the illustrated embodiment, pick unit 225 may be configured to pick instructions that are ready for execution and send the picked instructions to issue unit 230. In one embodiment, pick unit 225 may be configured to maintain a pick queue that stores a number of decoded and renamed instructions as well as information about the relative age and status of the stored instructions. During each execution cycle, this embodiment of pick unit 225 may pick up to one instruction per slot. For example, taking instruction dependency and age information into account, for a given slot, pick unit 225 may be configured to pick the oldest instruction for the given slot that is ready to execute.

In some embodiments, pick unit 225 may be configured to support load/store speculation by retaining speculative load/store instructions (and, in some instances, their dependent instructions) after they have been picked. This may facilitate replaying of instructions in the event of load/store misspeculation. Additionally, in some embodiments, pick unit 225 may be configured to deliberately insert “holes” into the pipeline through the use of stalls, e.g., in order to manage downstream pipeline hazards such as synchronization of certain load/store or long-latency FGU instructions.

Issue unit 230 may be configured to provide instruction sources and data to the various execution units for picked instructions. In one embodiment, issue unit 230 may be configured to read source operands from the appropriate source, which may vary depending upon the state of the pipeline. For example, if a source operand depends on a prior instruction that is still in the execution pipeline, the operand may be bypassed directly from the appropriate execution unit result bus. Results may also be sourced from register files representing architectural (i.e., user-visible) as well as non-architectural state. In the illustrated embodiment, core 100 includes a working register file 260 that may be configured to store instruction results (e.g., integer results, floating-point results, and/or condition code results) that have not yet been committed to architectural state, and which may serve as the source for certain operands. The various execution units may also maintain architectural integer, floating-point, and condition code state from which operands may be sourced.

Instructions issued from issue unit 230 may proceed to one or more of the illustrated execution units for execution. In one embodiment, each of EXU0 235 and EXU1 240 may be similarly or identically configured to execute certain integer-type instructions defined in the implemented ISA, such as arithmetic, logical, and shift instructions. In the illustrated embodiment, EXU0 235 may be configured to execute integer instructions issued from slot 0, and may also perform address calculation and for load/store instructions executed by LSU 245. EXU1 240 may be configured to execute integer instructions issued from slot 1, as well as branch instructions. In one embodiment, FGU instructions and multicycle integer instructions may be processed as slot 1 instructions that pass through the EXU1 240 pipeline, although some of these instructions may actually execute in other functional units.

In some embodiments, architectural and non-architectural register files may be physically implemented within or near execution units 235-240. It is contemplated that in some embodiments, core 100 may include more or fewer than two integer execution units, and the execution units may or may not be symmetric in functionality. Also, in some embodiments, execution units 235-240 may not be bound to specific issue slots, or may be differently bound than just described.

Load store unit 245 may be configured to process data memory references, such as integer and floating-point load and store instructions and other types of memory reference instructions. LSU 245 may include a data cache 250 as well as logic configured to detect data cache misses and to responsively request data from L2 cache 105. In one embodiment, data cache 250 may be configured as a set-associative, write-through cache in which all stores are written to L2 cache 105 regardless of whether they hit in data cache 250. As noted above, the actual computation of addresses for load/store instructions may take place within one of the integer execution units, though in other embodiments, LSU 245 may implement dedicated address generation logic. In some embodiments, LSU 245 may implement an adaptive, history-dependent hardware prefetcher configured to predict and prefetch data that is likely to be used in the future, in order to increase the likelihood that such data will be resident in data cache 250 when it is needed.

In various embodiments, LSU 245 may implement a variety of structures configured to facilitate memory operations. For example, LSU 245 may implement a data TLB to cache virtual data address translations, as well as load and store buffers configured to store issued but not-yet-committed load and store instructions for the purposes of coherency snooping and dependency checking. LSU 245 may include a miss buffer configured to store outstanding loads and stores that cannot yet complete, for example due to cache misses. In one embodiment, LSU 245 may implement a store queue configured to store address and data information for stores that have committed, in order to facilitate load dependency checking. LSU 245 may also include hardware configured to support atomic load-store instructions, memory-related exception detection, and read and write access to special-purpose registers (e.g., control registers).

Floating point/graphics unit 255 may be configured to execute and provide results for certain floating-point and graphics-oriented instructions defined in the implemented ISA. For example, in one embodiment FGU 255 may implement single- and double-precision floating-point arithmetic instructions compliant with the IEEE 754-1985 floating-point standard, such as add, subtract, multiply, divide, and certain transcendental functions. Also, in one embodiment FGU 255 may implement partitioned-arithmetic and graphics-oriented instructions defined by a version of the SPARC® Visual Instruction Set (VISTM) architecture, such as VISTM 2.0 or VISTM 3.0. In some embodiments, FGU 255 may implement fused and unfused floating-point multiply-add instructions. Additionally, in one embodiment FGU 255 may implement certain integer instructions such as integer multiply, divide, and population count instructions. Depending on the implementation of FGU 255, some instructions (e.g., some transcendental or extended-precision instructions) or instruction operand or result scenarios (e.g., certain denormal operands or expected results) may be trapped and handled or emulated by software.

In one embodiment, FGU 255 may implement separate execution pipelines for floating-point add/multiply, divide/square root, and graphics operations, while in other embodiments the instructions implemented by FGU 255 may be differently partitioned. In various embodiments, instructions implemented by FGU 255 may be fully pipelined (i.e., FGU 255 may be capable of starting one new instruction per execution cycle), partially pipelined, or may block issue until complete, depending on the instruction type. For example, in one embodiment floating-point add and multiply operations may be fully pipelined, while floating-point divide operations may block other divide/square root operations until completed.

Embodiments of FGU 255 may also be configured to implement hardware cryptographic support. For example, FGU 255 may include logic configured to support encryption/decryption algorithms such as Advanced Encryption Standard (AES), Data Encryption Standard/Triple Data Encryption Standard (DES/3DES), the Kasumi block cipher algorithm, and/or the Camellia block cipher algorithm. FGU 255 may also include logic to implement hash or checksum algorithms such as Secure Hash Algorithm (SHA-1, SHA-256, SHA-384, SHA-512), or Message Digest 5 (MD5). FGU 255 may also be configured to implement modular arithmetic such as modular multiplication, reduction and exponentiation, as well as various types of Galois field operations. In one embodiment, FGU 255 may be configured to utilize the floating-point multiplier array for modular multiplication. In various embodiments, FGU 255 may implement several of the aforementioned algorithms as well as other algorithms not specifically described.

The various cryptographic and modular arithmetic operations provided by FGU 255 may be invoked in different ways for different embodiments. In one embodiment, these features may be implemented via a discrete coprocessor that may be indirectly programmed by software, for example by using a control word queue defined through the use of special registers or memory-mapped registers. In another embodiment, the ISA may be augmented with specific instructions that may allow software to directly perform these operations.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. For example, in an embodiment employing 4 MB pages, a 64-bit virtual address and a 40-bit physical address, 22 address bits (corresponding to 4 MB of address space, and typically the least significant address bits) may constitute the page offset. The remaining 42 bits of the virtual address may correspond to the virtual page number of that address, and the remaining 18 bits of the physical address may correspond to the physical page number of that address. In such an embodiment, virtual to physical address translation may occur by mapping a virtual page number to a particular physical page number, leaving the page offset unmodified.

Such translation mappings may be stored in an ITLB or a DTLB for rapid translation of virtual addresses during lookup of instruction cache 205 or data cache 250. In the event no translation for a given virtual page number is found in the appropriate TLB, memory management unit 270 may be configured to provide a translation. In one embodiment, MMU 270 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk or a hardware table walk.) In some embodiments, if MMU 270 is unable to derive a valid address translation, for example if one of the memory pages including a necessary page table is not resident in physical memory (i.e., a page miss), MMU 270 may be configured to generate a trap to allow a memory management software routine to handle the translation. It is contemplated that in various embodiments, any desirable page size may be employed. Further, in some embodiments multiple page sizes may be concurrently supported.

As noted above, several functional units in the illustrated embodiment of core 100 may be configured to generate off-core memory requests. For example, IFU 200 and LSU 245 each may generate access requests to L2 cache 105 in response to their respective cache misses. Additionally, MMU 270 may be configured to generate memory requests, for example while executing a page table walk. In the illustrated embodiment, L2 interface 265 may be configured to provide a centralized interface to the L2 cache 105 associated with a particular core 100, on behalf of the various functional units that may generate L2 accesses. In one embodiment, L2 interface 265 may be configured to maintain queues of pending L2 requests and to arbitrate among pending requests to determine which request or requests may be conveyed to L2 cache 105 during a given execution cycle. For example, L2 interface 265 may implement a least-recently-used or other algorithm to arbitrate among L2 requestors. In one embodiment, L2 interface 265 may also be configured to receive data returned from L2 cache 105, and to direct such data to the appropriate functional unit (e.g., to data cache 250 for a data cache fill due to miss).

During the course of operation of some embodiments of core 100, exceptional events may occur. For example, an instruction from a given thread that is selected for execution by select unit 210 may not be a valid instruction for the ISA implemented by core 100 (e.g., the instruction may have an illegal opcode), a floating-point instruction may produce a result that requires further processing in software, MMU 270 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 275 may be configured to manage the handling of such events. For example, TLU 275 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 275 may be configured to flush all instructions from the trapping thread from any stage of processing within core 100, without disrupting the execution of other, non-trapping threads. In some embodiments, when a specific instruction from a given thread causes a trap (as opposed to a trap-causing condition independent of instruction execution, such as a hardware interrupt request), TLU 275 may implement such traps as precise traps. That is, TLU 275 may ensure that all instructions from the given thread that occur before the trapping instruction (in program order) complete and update architectural state, while no instructions from the given thread that occur after the trapping instruction (in program) order complete or update architectural state.

Additionally, in the absence of exceptions or trap requests, TLU 275 may be configured to initiate and monitor the commitment of working results to architectural state. For example, TLU 275 may include a reorder buffer (ROB) that coordinates transfer of speculative results into architectural state. TLU 275 may also be configured to coordinate thread flushing that results from branch misprediction. For instructions that are not flushed or otherwise cancelled due to mispredictions or exceptions, instruction processing may end when instruction results have been committed.

In various embodiments, any of the units illustrated in FIG. 2 may be implemented as one or more pipeline stages, to form an instruction execution pipeline that begins when thread fetching occurs in IFU 200 and ends with result commitment by TLU 275. Depending on the manner in which the functionality of the various units of FIG. 2 is partitioned and implemented, different units may require different numbers of cycles to complete their portion of instruction processing. In some instances, certain units (e.g., FGU 255) may require a variable number of cycles to complete certain types of operations.

Through the use of dynamic multithreading, in some instances, it is possible for each stage of the instruction pipeline of core 100 to hold an instruction from a different thread in a different stage of execution, in contrast to conventional processor implementations that typically require a pipeline flush when switching between threads or processes. In some embodiments, flushes and stalls due to resource conflicts or other scheduling hazards may cause some pipeline stages to have no instruction during a given cycle. However, in the fine-grained multithreaded processor implementation employed by the illustrated embodiment of core 100, such flushes and stalls may be directed to a single thread in the pipeline, leaving other threads undisturbed. Additionally, even if one thread being processed by core 100 stalls for a significant length of time (for example, due to an L2 cache miss), instructions from another thread may be readily selected for issue, thus increasing overall thread processing throughput.

As described previously, however, the various resources of core 100 that support fine-grained multithreaded execution may also be dynamically reallocated to improve the performance of workloads having fewer numbers of threads. Under these circumstances, some threads may be allocated a larger share of execution resources while other threads are allocated correspondingly fewer resources. Even when fewer threads are sharing comparatively larger shares of execution resources, however, core 100 may still exhibit the flexible, thread-specific flush and stall behavior described above.

### Control Transfer Unit and Target Addresses for Control Transfer Instructions

Turning now to FIG. 3, an embodiment of core 100 that includes a control transfer unit 381 is shown. Control transfer unit 381 may be located, in various embodiments, wholly within the instruction fetch unit (IFU) 200, partially within IFU 200, or wholly outside of IFU 200 (as shown in FIG. 3). FIG. 3 is exemplary of one embodiment and not meant to limit the location or connectivity of control transfer unit 381. In some embodiments, control transfer unit 381 may include any or all of the functionality and/or structures described with respect to “branch unit 380” as described in U.S. application Ser. No. 13/228,347, titled “BRANCH TARGET STORAGE AND RETRIEVAL IN AN OUT-OF-ORDER PROCESSOR,” filed Sep. 8, 2011, which is herein incorporated by reference. In the illustrated embodiment, control transfer unit 381 is configured to communicate with IFU 200 and branch execution unit 395. Branch execution unit 395 may be configured to determine the direction and/or target of CTIs (either speculatively and/or non-speculatively).

Turning now to FIG. 4A, a block diagram illustrating one embodiment of a computer instruction executable by processor 10 and/or core 100 is shown. As depicted, instruction 410 includes field 412 and one or more fields 414. Field 412 specifies an instruction type using a group of one or more bits, and may include information indicating that a particular instruction is a control transfer instruction (such as a jump, branch, or return, for example). Control transfer instructions may also include, in various embodiments, any other instruction that causes a non-linear program flow to occur (e.g., a program flow other than an automatic continuation of execution via incrementing a program counter). In other instances, however, field 412 may indicate that a given instruction is a different type of instruction, such as an add, multiplication, bit shift, etc. Accordingly, in some embodiments, field 412 includes an opcode that indicates the particular type of instruction 410, and this opcode may be used to determine whether a given instruction is a CTI. Further, note that in some embodiments, instruction 410 may be a type of control transfer instruction that also has other effects (e.g., an instruction may be considered to be a CTI even though it also causes a multiplication, addition, memory load, etc., to occur when executed).

As shown, instruction 410 also includes one or more fields 414 that are each configured to store additional data using a respective group of one or more bits. Data 414 may be, in various embodiments, any other data that one having skill in the art might wish to include in an instruction (such as operands, register designations, etc.). Instruction 410 may also be associated with one or more pre-decode bits 416, as well as a program counter (PC) value 418. However, in some embodiments, pre-decode bits 416 and/or PC value 418 are merely associated with instruction 410, and are not “part of” the instruction itself.

Control transfer instructions, in various embodiments, may use one of fields 414 to specify an offset value that corresponds to a control transfer to be performed. This offset value may be specified as a direct offset relative to program counter 418 in some embodiments. For example, a jump instruction may specify that when executed, program control should jump to the instruction stored at the address stored at memory location PC+offset, where PC is the value of the program counter corresponding to the jump instruction, and offset is the value specified within the jump instruction (e.g., the value specified by one of fields 414). (See FIGS. 4B-4C for an additional specific example). In this example, the “target address” of the jump CTI is said to be the value “PC+offset”.

Offsets may, in various embodiments, be either indirect or direct. A direct offset is a literal value, e.g., ‘10011100000’, representing the number 1248 in binary. Indirect offsets, as discussed herein, are information that is usable to determine the location of a direct offset. For example, an indirect offset may specify that the value currently held by “register 6” should be used as a direct offset to the program counter for a particular CTI. Accordingly, in this example, the target address of the CTI having an indirect offset is said to be “PC+[value from register 6]”.

Note that in general, bits may be truncated from program counter addresses, target address, and/or CTI offset values in order to conserve space in various embodiments. For example, in a machine that is four-byte (32 bit) aligned, the least significant two bits of an program counter, target address, and offset may all be omitted because they will always be assumed to be ‘00’. In other embodiments, a smaller or larger number of least significant bits may be truncated from program counter addresses, target addresses, CTI offset values, and/or other information used by processor 10.

Turning now to FIGS. 4B and 4C, block diagrams are shown illustrating an instruction 440 before and after a modification (which may be performed by control transfer unit 500, as further discussed below relative to FIG. 5). A shown, instruction 440 includes a field 442 specifying that this instruction is a jump to be performed relative to an offset value stored in field 444 (depicted as the decimal value 20, or 10100 in binary). In the embodiment of FIGS. 4B-4C, field 446 is configured to store a group of one or more pre-decode bits, and field 448 is configured to store a PC value for instruction 440. As depicted, fields 446 and 448 correspond to instruction 440, but are not explicitly part of instruction 440. Additional information not shown may be included by or associated with instruction 440. In FIG. 4B, the target address of instruction 440 has not yet been calculated, but is equal to the PC value (field 448) plus the offset value (field 444).

In FIG. 4C, the target address value has been calculated to be 1020 (or 1111111100 in binary). Instruction field 444 has been modified, and no longer includes the previously specified offset value. Instead, field 444 includes a portion of the computed target address—in this case, the least six (6) significant bits of the target address. Note that these least eight significant bits can be concatenated with the two most significant bits of PC value 448 in order to reconstruct the full target address of the jump instruction. Accordingly, as modified, instruction 444 includes information that is usable to reconstruct the target address without processor 10 having to performing a further addition operation, which may produce a subsequent savings of power and/or execution time, as further discussed below relative to FIG. 5.

One of the pre-decode bits in field 446 has also been changed to the value one (1) in the embodiment of FIG. 4C. This pre-decode bit indicates that instruction 440 has been modified to include a portion of the target address (rather than including a specified offset value, for example). Accordingly, other circuitry in control transfer unit 500 or elsewhere in processor 10 and/or core 100 may examine this pre-decode bit to determine if a target address has already been calculated. In other embodiments, however, information indicating that a CTI has been modified to include at least a portion of a target address may be stored in locations other than pre-decode bits. For example, in one embodiment, such information is stored within a field of the CTI itself (e.g., within one of fields 414).

Turning now to FIG. 5, a block diagram illustrating one embodiment of a control transfer unit 500 is shown. Control transfer unit 500 may be configured to perform various operations with regard to control transfer instructions, including target address calculation and instruction modification, as described below. Control transfer unit 500 may include any or all of the features of control transfer unit 381 in various embodiments, and as such, may be located partially or wholly within an instruction fetch unit. Control transfer unit 500 and its components may be implemented as one or more electrical circuits. In one embodiment, control transfer unit is part of partial decode circuitry that is active when an instruction cache miss is returning (e.g., from one cache level to another cache level, such as L2 cache to L1 cache).

As depicted, control transfer unit 500 is configured to receive instructions via one or more input(s) 502, which may be connected to a bus, cache, communication line(s), or other structure(s) via which instructions can be accessed. Input 502 may also be configured in various embodiments to deliver additional data, such as program counter (PC) values, thread ID values, pre-decode bits, and/or other information that may correspond to instructions. Control transfer unit 500 is likewise configured to output instructions and/or additional data via one or more output(s) 504. In various embodiments, input 502 and output 504 may be connected to a branch execution unit, an instruction fetch unit, an instruction cache (L1, L2, L3, etc.), and/or other portions of processor 10 and/or core 100. Accordingly, in some embodiments, control transfer unit 500 is configured to compute a target address and modify a CTI to include at least a portion of the target address in association with and/or prior to the CTI being stored in an instruction cache.

In the embodiment of FIG. 5, control transfer unit 500 includes control transfer detection logic 510, near target determination logic 515, target address calculation logic 520, modification indication logic 525, and instruction modification logic 530. Control transfer (CT) detection logic 510 is configured, in the embodiment shown, to detect whether a control transfer instruction is present in a group of one or more instructions. In some embodiments, CT detection logic 510 is configured to determine whether an instruction is a control transfer by analyzing the opcode and/or instruction type of the instruction. CT detection logic 510 may also be configured, in one embodiment, to determine whether a control transfer instruction specifies an offset value for a control transfer to be performed. In one embodiment, if an instruction is detected to be a CTI that specifies an offset value, further processing of that instruction by control transfer unit 500 may be performed as described below. In the event that an instruction is not a control transfer, however, control transfer unit 500 may take no further action on that instruction in various embodiments.

In the embodiment of FIG. 5, target address calculation logic 520 is configured to compute a target address for a control transfer instruction. In one embodiment, this operation may be performed in response to detection logic 510 determining that an instruction is a control transfer. Calculation logic 520 is configured, in various embodiments, to compute a target address by adding the PC value for a CTI to the offset value that is specified by the CTI. In other embodiments, however, address calculation logic 520 may be configured to calculate the target address by adding a PC value for the CTI to an offset value that is located elsewhere and not within the CTI itself (e.g., an indirect offset). For example, logic 520 may be configured, in some embodiments, to determine an offset value from a register, from a subsequent or previous instruction, or from another storage location within a processor 10, core 100, and/or control transfer unit 500. Calculation logic 520 may thus be configured to include an arithmetic addition unit in at least one embodiment.

In the embodiment of FIG. 5, instruction modification logic 530 is configured to modify a CTI to include at least a portion of a target address after it has been calculated. For example, logic 530 may modify a CTI by changing an instruction field such as 414 or 444 so that that modified instruction will include one or more bits of data that make up a computed target address for that CTI. For example, a number of least significant bits of the target address may be included in the CTI, as shown in FIG. 4C. Thus in various embodiments, some number of bits fewer than the full length of the target address may be stored in the modified CTI. In other embodiments, however, a full target address may be stored within a modified CTI. In some embodiments, portions of an instruction other than field(s) 414, or other data, may be modified by logic 530.

In one embodiment, instruction modification logic 530 is configured to determine how big of a portion of a computed target address should be stored within a CTI (e.g., determine what number of least significant bits from the computed target address should be used). In making this determination, modification logic 530 may consider the number of “available” bits for that CTI. Including an overly large portion of the computed target address, for example, could cause other critical information within the CTI to be overwritten, which would be undesirable. Accordingly, the amount of free space within the CTI may be considered. In one embodiment, the amount of available space in a CTI in which to store a portion of a target address is simply the exact number of bits usable by that type of CTI to specify an offset. Accordingly, in one embodiment, if a first type of CTI allows 12 bits (at most) to be used to specify an offset, then only up to 12 bits of the computed target address should be written into the CTI during modification (so as to avoid potentially overwriting other instruction fields). Thus in at least one embodiment, when a CTI is modified to include at least a portion of a computed target address, that portion is written into the instruction field 414 that previously held a specified offset value. In other embodiments, however, additional instruction fields may be overwritten to include a portion of a calculated target address.

Note that in some embodiments, a processor architecture may support multiple types of CTIs that have different (maximum) widths of offset fields. For example, a machine may support three different types of CTIs that respectively allow offsets to be specified using a 29 bit field, a 16 bit field, or a 12 bit field. Accordingly, in some embodiments, a particular type of CTI may have less available free space (e.g., 12 bits instead of 16 bits or 29 bits) in which to store a portion of a computed target address. As such, control transfer unit 500 may be configured to handle different CTI types in different ways, according to their particular specifications. Thus in one embodiment, a first CTI type may be modified to include a larger portion of a target address, while another CTI type may be modified to include a smaller portion of a target address. However, in another embodiment, a “lowest common denominator” approach is used, and all CTI types are modified to include only the same (maximum) length portion of a target address, regardless of whether some CTI types may have excess free space relative to that maximum length, as further discussed below.

In some embodiments, and under some circumstances, there may be insufficient free space within a CTI in which to store an adequate portion of a computed target address. For example, in one embodiment, if X is the number of available “free” bits of storage space within a CTI, a target address can be accurately reconstructed by concatenating the least X significant bits of the target address (i.e., the portion of the target address that is stored within a modified instruction) with all higher bits from the PC value for that CTI (e.g., all of the PC value except for its least significant X bits, which are instead replaced by the stored portion of the target address). Accordingly, in this embodiment, it is desirable for the following condition to be true in order to avoid a potential information overflow when writing a portion of a target address into an instruction being modified:

X≧Length of(Offset value specified by CTI+Least significant X bits of PC)

In other words, the difference between the target address (PC+offset) and the original PC value may determine whether a given CTI has a target that is too “far” from the PC value, in that there will insufficient space within the CTI in which to store an adequate portion of the target address. Accordingly, if the above condition is false in this embodiment, then processor 10 may not be able to accurately reconstruct the target address via concatenation because X bits of storage space within the CTI will not be enough. Accordingly, if a CTI target address is too “far” from the PC value for the CTI in one embodiment, control transfer unit 500 will have to leave the CTI unmodified.

In the embodiment of FIG. 5, near target determination logic 515 is configured to make a determination as to whether the target address for a given CTI is a “near” target relative to the PC value for that CTI (in which case instruction modification may proceed), or whether the target address represents a “far” target (in which case the instruction will not be modified). The actual determination of whether a given CTI is a “near” or “far” CTI can be performed in a variety of ways. In one embodiment in which 11 bits of storage space are available in which to store a portion of a target address, near target determination logic 515 examines the number of significant bits in the offset for a given CTI. If the number of significant bits in the CTI offset is below a threshold (e.g., 10 bits or less), then the near target determination logic will output an indication that the CTI is a “near” CTI, and should be modified accordingly. This is because when determining the CTI target address by adding the PC value to the 10-bit (or less) offset, the resultant target address will not differ from the PC by more than an 11 bit amount, due to properties of binary arithmetic. Thus, if the offset is 10 bits or less in this example, and 11 bits are allowed for storage within an instruction, there should be no problem successfully reconstructing the target address from those 11 bits and the PC value.

Similarly, a CTI target may be deemed a “far” target if the number of significant bits in the CTI offset is above a threshold number of bits. Continuing the example above, in the embodiment of FIG. 5, near target determination logic 515 will output an indication that a CTI has a far target if the CTI offset is 12 bits or greater (as only 11 bits are available for storage). However, an additional check may need to be performed in the embodiment of FIG. 5 if the number of significant bits in the offset for the CTI is equal to the threshold number of bits (e.g., if a CTI specifies an 11 bit offset and also has only 11 bits available for storage of a portion of the target address). In this case, an overflow condition may or may not exist depending on the specific values of the PC and offset.

Consider, as a simplified example, a CTI in which 4 bits are available to store portions of a target address (ignoring any sign bits). If the offset is between 1000 and 1111 (i.e., is equal to the number of bits available to be modified), then whether the CTI is “near” or “far” depends on the PC. If the offset is 1000, any PC value that has 0111 or less as its four least significant bits will result in the CTI being “near,” because the 4-bit offset plus the least 4 significant PC bits are only equal to the threshold number of 4 bits (recall the formula listed above). However, continuing this example, if the offset is 1111, only a PC value for the CTI that has its four least significant bits as 0000 will cause the CTI to be classified as near (because otherwise, the 4-bit offset plus the least 4 significant PC value bits would be equal to 5 bits, and greater than the threshold number of 4 bits). Accordingly, in one embodiment, near target determination logic 515 is configured to determine whether a CTI has a “near” target by comparing a calculated target address (e.g., from calculation logic 520) with the PC value. If the most significant N-X bits of a calculated target address are the same as the PC value for a CTI (where N is the maximum PC value length, and X is the amount of storage space available in the CTI for modification), then the CTI will be deemed have a “near” target. Otherwise, the CTI will be deemed to have a “far” target.

Whether or not various operations are performed by the control transfer unit in the embodiment of FIG. 5 may depend on the determination of whether a CTI is near (and thus suitable for modification) or far (and thus unsuitable for modification). For example, if a CTI is determined to be far, then instruction modification logic 530 will not modify the CTI to include a portion of the target address. However, if the CTI is determined to have a near target, then the CTI will be modified accordingly. Thus, control transfer unit 500 is configured, in one embodiment, to modify the CTI based on a determination that the target address for the CTI is within a certain range of a program counter (PC) value for the CTI, and not modify the CTI based on a determination that the target address for the CTI is outside of a certain range of the PC value. In some embodiments, the target address for a CTI may not ever actually be calculated by calculation logic 520 if it is determined that the CTI has a far target. For example, in the embodiment of FIG. 5, when an offset for a CTI is larger than the amount of space available in the CTI, then calculation logic 520 may not attempt to determine the actual target address (thereby potentially saving power). Such a situation may arise, in particular, in embodiments in which one type of CTI has an offset field that is of greater maximum width than an offset field for another type of CTI. In another embodiment, however, target address calculation logic 520 will always calculate the target address for a CTI having a specified offset, but near target determination logic will cause further processing to be halted if a far target is detected (i.e., the CTI will not be modified by instruction modification logic 530).

As stated above, a machine may support multiple varieties of CTIs in which offsets are specified using different width fields for each different type of CTI. For example, a machine may support CTIs having specified offsets that use up to 29 bits, 16 bits, or 12 bits of information, respectively. In such a machine, these bit widths may represent the maximum available space that each CTI has in which to store at least a portion of a computed target address. Accordingly, in some embodiments, a particular type of CTI may have less available space (e.g., 12 bits instead of 16 bits or 29 bits) for storing a portion of a target address. In this case, the width for the CTI type having the least available space may simply be used as a “lowest common denominator” for all CTIs, in order to simplify operations performed by control transfer unit 500 and/or operations performed elsewhere in processor 10 and/or core 100. Thus, in the embodiment discussed above, a “near” target address may be any target address within 12 bits of a corresponding PC value for a CTI, even if that CTI actually has 16 or 29 bits of storage space available. Accordingly, different threshold values may be used in different embodiments to determine whether a given CTI is “near” or “far.” In some embodiments, whether a CTI is near or far may also depend on the direction of the target address relative to the PC (e.g., different threshold values and different determinations may be used depending on whether the target address is higher or lower than the PC value). In other embodiments, however, control transfer unit 500 is configured to handle CTIs having different storage capabilities differently. Accordingly, in such embodiments, whether a given CTI has a “near” or “far” target address may depend on the particular maximum storage width available in that CTI (and not, for example, on the shortest maximum width available for all CTI types in that machine).

Modification indicator logic 525 is configured, in the embodiment of FIG. 5, to store information indicating that a CTI has been modified to include at least a portion of a target address. It may be valuable to record this information, for example, because other portions of processor 10 and/or core 100 (such as branch execution unit 395) may be configured to handle a CTI differently depending on whether it has been modified or not. In at least one embodiment, modification indicator logic 525 is configured to store such information in one or more pre-decode bits associated with a given CTI (as in the embodiment illustrated in FIGS. 4B-4C). In other embodiments, however, modification indicator logic may be configured to store information indicating that a CTI has been modified within the CTI itself (e.g., within one of fields 414), or elsewhere within control transfer unit 500, processor 10, and/or core 100.

Indeed, in the embodiment of FIG. 3, branch execution unit 395 is configured to perform operations differently based on whether a CTI has been modified by a control transfer unit. If a CTI has not been modified (for example, if the CTI had a “far” target), then branch execution unit 395 may compute a target address by first determining the offset for the CTI (e.g., by extracting the offset from one of fields 414 or from elsewhere in processor 10 and/or core 100). After determining the offset, unit 395 may then perform an addition, subtraction, or other mathematic operation to ascertain the actual target address, which may involve the expenditure of power and time. However, in the event that at least a portion of the target address has already been stored in the CTI, branch execution unit 395 may reconstruct the target address by concatenating the stored portion with at least a portion of the program counter that corresponds to that CTI (i.e., without the need to perform a mathematical addition operation). Such a concatenation operation may be less complex than the branch execution unit (re)computing the target address, and accordingly, may produce savings of power and/or time in various embodiments.

Turning now to FIG. 6, a flow diagram illustrating one embodiment of a method 600 in which a control transfer instruction may be modified is shown. Any or all of the steps of method 600 may be performed, in various embodiments, by control transfer unit 500. Method 600 may also be performed relative to a group of one or more instructions, and may be repeated for each instruction in the group. Method 600 may also be performed in parallel for two or more instructions (i.e., instructions within a same group). In various embodiments, steps of method 600 may be performed in a different order than shown. For example, in some embodiments, steps 610, 620, and 630 may be performed simultaneously and/or in a different order with respect to each other, while in other embodiments steps 640 and 650 may be performed simultaneously and/or in a different order with respect to each other.

In step 610, control transfer unit 500 determines an instruction is a control transfer instruction. This step is performed, in one embodiment, by control transfer detection logic 510. If the instruction is not a CTI, method 600 exits by proceeding to step 660. In step 620, control transfer unit determines whether the CTI specifies an offset. For example, in one embodiment, step 620 may seek to determine whether a particular offset is specified, relative to a PC for the CTI, as a field of one or more bits within the CTI itself. If no offset is specified by the CTI, method 600 exits by proceeding to step 660; otherwise, if an offset is specified, method 600 proceeds to step 630. Accordingly, in one embodiment, steps 630, 640, and/or 650 can be said to be performed in response to determining that a group of one or more instructions includes a CTI that specifies an offset for a control transfer to be performed.

In step 630, a target address for the CTI is calculated. This step is performed, in one embodiment, by target address calculation logic 520. In one embodiment, step 630 is performed prior to storing the CTI within an instruction cache (e.g., an L1 cache). In step 640, at least a portion of the calculated target address is stored within the CTI. This step may be performed, in some embodiments, by instruction modification logic 530.

In step 650, an indication that the target address has been calculated is stored. This indication is stored, in one embodiment, as a pre-decode bit associated with the CTI, where the pre-decode bit also indicates that the CTI has been modified to include at least a portion of the target address.

In method 600, processor 10 and/or core 100 may be configured, in response to the stored information indicating that the target address has been calculated (and/or in response to information indicating that the CTI has been modified to include at least a portion of the target address), to reconstruct the calculated target address by concatenating the stored at least a portion of the calculated target address with at least a portion of a program counter (PC) value corresponding to the CTI. Further, as previously noted, method 600 may be performed on multiple instructions within a group of instructions. Accordingly, in one embodiment, a group of instructions includes at least a second CTI that specifies a second offset for a control transfer to be performed, and method 600 further comprises calculating at least a second target address for the second CTI and causing at least a portion of the second calculated target address to be stored in the second CTI. In this embodiment, calculating the second target address may be performed within a same number of clock cycles as calculating the target address (e.g., the steps of method 600 for the first and second CTI may be performed wholly or partially in parallel).

In various embodiments, control transfer unit 381 may include any or all of the functionality and structures described relative to control transfer unit 500. Accordingly, processor 10 and/or processor core 100 are apparatuses, in various embodiments, that are configured to perform method 600. Note that in one embodiment, processor 10 includes at least a level 1 (L1) cache and a level 2 (L2) cache, where the L1 and L2 cache each include a plurality of storage locations corresponding to a plurality of instructions (i.e., storage of instructions to be executed by processor 10). In this embodiment, each of the plurality of storage locations is configured to store information indicating whether the corresponding instruction is a CTI that has been modified to include at least a portion of a target address. Accordingly, in this embodiment, both an L1 and L2 cache may be able to tell whether an instruction is a CTI modified in accordance with techniques described herein.

In another embodiment, modified CTIs and stored information associated with modified CTIs may be accessed in a thread agnostic fashion. That is, in such in embodiment, once a CTI has been modified for a first thread, a second thread that later executes that same CTI will not need to recalculate the target address when executing the same CTI. (E.g., branch execution unit 395, even when executing a different thread, may be able to detect that a CTI has already been modified previously, and thus a concatenation operation will be sufficient to reconstruct the target address). Of course, in various embodiments, the subsequent execution of an already modified CTI may be affected in response to stored information indicating such. Thus, in one embodiment, control transfer unit 500 will take no further action for a CTI if it detects that the CTI already includes at least a portion of its target address. Likewise, some or all steps of method 600 may be omitted for a CTI that has already been modified.

### Exemplary System Embodiment

As described above, in some embodiments, processor 10 of FIG. 1 may be configured to interface with a number of external devices. One embodiment of a system 700 including processor 10 is illustrated in FIG. 7. In the illustrated embodiment, system 700 includes an instance of processor 10, shown as processor 10a, that is coupled to a system memory 710, a peripheral storage device 720 and a boot device 730. System 700 is coupled to a network 740, which is in turn coupled to another computer system 750. In some embodiments, system 700 may include more than one instance of the devices shown. In various embodiments, system 700 may be configured as a rack-mountable server system, a standalone system, or in any other suitable form factor. In some embodiments, system 700 may be configured as a client system rather than a server system.

In some embodiments, system 700 may be configured as a multiprocessor system, in which processor 10a may optionally be coupled to one or more other instances of processor 10, shown in FIG. 10 as processor 10b. For example, processors 10a-b may be coupled to communicate via their respective coherent processor interfaces 160.

In various embodiments, system memory 710 may comprise any suitable type of system memory as described above, such as FB-DIMM, DDR/DDR2/DDR3/DDR4 SDRAM, RDRAM®, flash memory, and of various types of ROM, etc. System memory 710 may include multiple discrete banks of memory controlled by discrete memory interfaces in embodiments of processor 10 that provide multiple memory interfaces 130. Also, in some embodiments, system memory 710 may include multiple different types of memory.

Peripheral storage device 720, in various embodiments, may include support for magnetic, optical, or solid-state storage media such as hard drives, optical disks, nonvolatile RAM devices, etc. In some embodiments, peripheral storage device 720 may include more complex storage devices such as disk arrays or storage area networks (SANs), which may be coupled to processor 10 via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processor 10, such as multimedia devices, graphics/display devices, standard input/output devices, etc. In one embodiment, peripheral storage device 720 may be coupled to processor 10 via peripheral interface(s) 150 of FIG. 1.

As described previously, in one embodiment boot device 730 may include a device such as an FPGA or ASIC configured to coordinate initialization and boot of processor 10, such as from a power-on reset state. Additionally, in some embodiments boot device 730 may include a secondary computer system configured to allow access to administrative functions such as debug or test modes of processor 10.

Network 740 may include any suitable devices, media and/or protocol for interconnecting computer systems, such as wired or wireless Ethernet, for example. In various embodiments, network 740 may include local area networks (LANs), wide area networks (WANs), telecommunication networks, or other suitable types of networks. In some embodiments, computer system 750 may be similar to or identical in configuration to illustrated system 700, whereas in other embodiments, computer system 750 may be substantially differently configured. For example, computer system 750 may be a server system, a processor-based client system, a stateless “thin” client system, a mobile device, etc. In some embodiments, processor 10 may be configured to communicate with network 740 via network interface(s) 160 of FIG. 1.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a control transfer unit configured to receive a control transfer instruction (CTI) that specifies a control transfer to be performed relative to an offset;
wherein the control transfer unit is configured to compute a target address for the CTI based on the offset, wherein the control transfer unit is configured to modify the CTI to include at least a portion of the computed target address, and wherein the portion of the computed target address is usable by the apparatus to reconstruct the computed target address.

2. The apparatus of claim 1, wherein the apparatus is configured to store information indicating that the CTI has been modified to include the at least a portion of the computed target address.

3. The apparatus of claim 2, wherein the apparatus is configured to store the information in one or more pre-decode bits corresponding to the CTI.

4. The apparatus of claim 1, further comprising:
an instruction cache;
wherein the control transfer unit is configured to compute the target address for the CTI and modify the CTI in association with the CTI being stored in the instruction cache.

5. The apparatus of claim 1, wherein the apparatus is configured to reconstruct the target address for the CTI by concatenating the stored at least a portion of the computed target address with at least a portion of a program counter (PC) value corresponding to the CTI.

6. The apparatus of claim 5, further comprising one or more execution units that are configured to reconstruct the target address for the CTI without performing an addition operation.

7. The apparatus of claim 1, wherein the offset is specified in the CTI; and
wherein the control transfer unit is configured to:
modify the CTI based on a determination that the target address for the CTI is within a certain range of a program counter (PC) value for the CTI; and
not modify the CTI based on a determination that the target address for the CTI is outside of a certain range of the PC value.

8. The apparatus of claim 1, wherein the control transfer unit is configured to:
compute target addresses for a plurality of different types of CTIs and modify instructions of the different types to include at least portions of the computed targeted addresses;
wherein the control transfer unit is configured to modify a first of the plurality of different types of CTIs to include a larger portion of a computed address than a portion of included in a second one of the plurality of different types of CTIs.

9. A method, comprising:
in response to determining that a group of one or more instructions includes a control transfer instruction (CTI) that specifies an offset for a control transfer to be performed:
calculating, by a circuit, a target address for the CTI based on the specified offset; and
the circuit causing at least a portion of the calculated target address to be stored in the CTI.

10. The method of claim 9, further comprising the circuit causing information indicating that the target address has been calculated to be stored within a processor that includes the circuit.

11. The method of claim 10, further comprising the processor, in response to the stored information, reconstructing the calculated target address by concatenating the stored at least a portion of the calculated target address with at least a portion of a program counter (PC) value corresponding to the CTI.

12. The method of claim 9, wherein the circuit is coupled to an instruction fetch unit of a processor.

13. The method of claim 9, wherein the circuit is configured to perform said calculating prior to the CTI being stored in a level 1 (L1) instruction cache.

14. The method of claim 9, wherein the group of instructions includes at least a second CTI that specifies a second offset for a control transfer to be performed; and
wherein the method further comprises the circuit calculating at least a second target address for the second CTI and causing at least a portion of the second calculated target address to be stored in the second CTI;
wherein calculating the second target address is performed within a same number of clock cycles as calculating the target address.

15. An apparatus, comprising:
a circuit configured to modify a control transfer instruction (CTI) to include at least a portion of a target address corresponding to the control transfer instruction;
wherein the circuit is configured to modify the CTI based on an offset field of the CTI specifying an offset value for a control transfer to be performed.

16. The apparatus of claim 15, wherein the circuit is configured to calculate the target address for the CTI based on the specified offset value and a program counter (PC) value corresponding to the CTI.

17. The apparatus of claim 15, wherein the circuit is configured to cause information indicating that the CTI includes the at least a portion of the target address to be stored in a group of one or more pre-decode bits associated with the CTI.

18. The apparatus of claim 15, wherein the circuit is configured to modify the CTI to include the at least a portion of the target address based on a determination that the offset value is below a threshold value.

19. The apparatus of claim 15, wherein the apparatus is a multi-thread processor that includes at least a level 1 (L1) cache and a level 2 (L2) cache, and wherein the L1 and L2 cache each include a plurality of storage locations corresponding to a plurality of instructions, wherein each of the plurality of storage locations is configured to store information indicating whether the corresponding instruction is a CTI that has been modified to include at least a portion of a target address.

20. The apparatus of claim 15, wherein the apparatus is a multi-threaded processor; and
wherein for a first CTI that corresponds to a first thread and that has been modified to include at least a portion of a target address, the apparatus is configured, in response to stored information indicating that the first CTI has been modified, not to recalculate the target address when executing a second thread that also includes the first CTI.
